(19) United States
(12) Patent Application Publication
(10) Pub. No.: US 2019/0308417 A1
(43) Pub. Date: Oct. 10, 2019

(54) CAPPING MECHANISM AND INKJET PRINTER

(71) Applicant: MIMAKI ENGINEERING CO., LTD., Nagano (JP)

(72) Inventor: Kota Tomioka, NAGANO (JP)

(73) Assignee: MIMAKI ENGINEERING CO., LTD., Nagano (JP)

(21) Appl. No.: 16/351,437

(22) Filed: Mar. 12, 2019

(30) Foreign Application Priority Data
Apr. 6, 2018 (JP) 2018-073559

(51) Int. Cl. B41J 2/165

(52) U.S. Cl. CPC B41J 2/16508; B41J 2/16523

(57) ABSTRACT

To provide a capping mechanism that enables a replacement task of a cap body, to which ink suctioned from nozzles of an inkjet head adheres, to be simplified. The capping mechanism that covers a nozzle surface of the inkjet head in which a plurality of nozzles are arrayed and suctions the ink from the nozzles includes the cap body that covers the nozzle surface from a lower side, a first case body to which the cap body is detachably attached, a tube having one end attached to the first case body, and a suction mechanism to which the other end of the tube is connected. In the capping mechanism, when the suction mechanism is driven with the cap body covering the nozzle surface and brought into close contact with the inkjet head, ink is suctioned from the nozzles.

### CROSS REFERENCE TO RELATED APPLICATIONS

This application claims the priority benefit of Japanese Patent Application No. 2018-073559, filed on Apr. 6, 2018. The entirety of the above-mentioned patent application is hereby incorporated by reference herein and made a part of this specification.

### TECHNICAL FIELD

The present disclosure relates to a capping mechanism that covers a nozzle surface of an inkjet head and suctions ink from nozzles. The present disclosure also relates to an inkjet printer equipped with such a capping mechanism.

### DESCRIPTION OF THE BACKGROUND ART

A capping mechanism used by being mounted on an inkjet printer is conventionally known (see, e.g., Japanese Unexamined Patent Publication No. 2012-176563). The capping mechanism described in Japanese Unexamined Patent Publication No. 2012-176563 is brought into close contact with a nozzle surface (ink ejection surface) of an inkjet head, in which a plurality of nozzles are arrayed, to cover the nozzle surface and suctions and collects ink from the nozzles. The capping mechanism includes a cap member that covers the nozzle surface, a support plate that floatingly supports the cap member by way of a compression coil spring, and a cap slide member to which the support plate is fixed.

In the capping mechanism described in Japanese Unexamined Patent Publication No. 2012-176563, one end of each of a plurality of ink suction tubes is connected to the cap member by way of a tube connecting tool. The other end of each ink suction tube is connected to a suction mechanism. An opposing surface of the cap member that covers the nozzle surface is covered with a nonwoven fabric sheet having flexibility and hygroscopicity. In the capping mechanism described in Japanese Unexamined Patent Publication No. 2012-176563, the ink suctioned from the nozzles of the inkjet head is passed through the ink suction tubes and collected in a waste ink container.

In the capping mechanism described in Japanese Unexamined Patent Publication No. 2012-176563, the ink suctioned from the nozzles adheres to the cap member suctioning and collecting the ink from the nozzles of the inkjet head, and thus the cap member to which the ink adheres needs to be periodically replaced. Furthermore, in the capping mechanism described in Japanese Unexamined Patent Publication No. 2012-176563, since one end of each ink suction tube is connected to the cap member by way of the tube connecting tool, attachment/detachment task of the ink suction tube with respect to the cap member needs to be carried out when replacing the cap member.

However, the attachment/detachment task of the ink suction tube with respect to the cap member is a cumbersome task, and in the capping mechanism described in Japanese Unexamined Patent Publication No. 2012-176563, the cumbersome attachment/detachment task of the ink suction tube needs to be carried out when replacing the cap member. Thus, in the capping mechanism, the replacement task of the cap member is cumbersome.

In addition, in a case where the inkjet printer equipped with the capping mechanism is a business inkjet printer, it is generally prohibited for the user to touch the portion through which the ink is flowing, and the user cannot perform the attaching/detaching operation of the tube. For this reason, when the capping mechanism described in Japanese Unexamined Patent Publication No. 2012-176563 is used in a business inkjet printer, a maintenance worker who performs maintenance of the inkjet printer has to perform the replacement task of the cap member, and the user cannot perform the replacement task of the cap member.

### SUMMARY

The present disclosure provides a capping mechanism that covers a nozzle surface of an inkjet head and suctions ink from nozzles, the capping mechanism capable of simplifying a replacement task of a cap body to which the ink suctioned from the nozzles of the inkjet head adheres. The present disclosure further provides an inkjet printer equipped with such a capping mechanism.

In order to solve the problem described above, a capping mechanism of the present disclosure is a capping mechanism that covers a nozzle surface of an inkjet head in which a plurality of nozzles are arrayed and suctions ink from the nozzles; the capping mechanism including a cap body that covers the nozzle surface from a lower side, a first case body to which the cap body is detachably attached, a tube having one end attached to the first case body, and a suction mechanism to which the other end of the tube is connected; where when the suction mechanism is driven with the cap body covering the nozzle surface and brought into close contact with the inkjet head, ink is suctioned from the nozzles.

In the capping mechanism of the present disclosure, the one end of the tube, the other end of which is connected to the suction mechanism, is attached to the first case body. Furthermore, in the present disclosure, the cap body covering the nozzle surface from the lower side is detachably attached to the first case body. Therefore, in the present disclosure, when replacing the cap body to which the ink suctioned from the nozzles of the inkjet head adheres, an attachment/detachment task of the cap body can be performed with respect to the first case body to which the one end of the tube is attached. That is, in the present disclosure, the attachment/detachment task of the tube with respect to the cap body does not need to be carried out when replacing the cap body. Therefore, according to the present disclosure, the replacement task of the cap body can be simplified.

In the present disclosure, the capping mechanism preferably includes a second case body that holds the first case body such that the first case body is movable up and down, and a biasing member that biases the first case body to the upper side with respect to the second case body. With this configuration, the cap body can be reliably brought into close contact with the inkjet head by a biasing force of the biasing member.

In the present disclosure, either one of the cap body and the first case body is preferably provided with an elastically deformable engagement piece that projects out toward the other one of the cap body and the first case body, and that engages the other one of the cap body and the first case body by snap-fit. That is, in the present disclosure, the cap body is preferably detachably attached to the first case body by snap-fit. With this configuration, the attachment/detachment task of the cap body with respect to the first case body is facilitated compared to a case where the cap body is detachably attached to the first case body by screws. Therefore, the replacement task of the cap body can be further simplified.

In the present disclosure, the cap body is preferably attached to the first case body from an upper side, one end of the tube is preferably attached to a lower end of the first case body, a through hole that passes through the first case body in a vertical direction and communicates to an inner peripheral side of the tube is preferably formed in the first case body, a tubular projection that projects out toward the lower side and is inserted to an upper end of the through hole is preferably formed on the cap body, and a seal member formed of an elastic body is preferably disposed between an inner peripheral surface of the upper end of the through hole and an outer peripheral surface of the projection. With such a configuration, even if the cap body is detachably attached with respect to the first case body, leakage of air and ink suctioned by the suction mechanism between the first case body and the cap body can be prevented.

The capping mechanism of the present disclosure can be used in an inkjet printer including an inkjet head and a carriage on which the inkjet head is mounted. In this inkjet printer, the replacement task of the cap body can be simplified in the capping mechanism.

In the capping mechanism of the present disclosure, since the attachment/detachment task of the tube does not need to be carried out when replacing the cap body, a user can perform the replacement task of the cap body even if the inkjet printer where the capping mechanism of the present disclosure is used is a business inkjet printer.

As described above, in the present disclosure, in the capping mechanism that covers the nozzle surface of the inkjet head and suctions the ink from the nozzles, the replacement task of the cap body to which the ink suctioned from the nozzles of the inkjet head adheres can be simplified.

### BRIEF DESCRIPTION OF THE DRAWINGS

FIG. 1 is a perspective view of an inkjet printer according to an embodiment of the present disclosure;

FIG. 2 is a schematic view showing a carriage and the like of the inkjet printer shown in FIG. 1;

FIG. 3 is an exploded perspective view describing a configuration of a capping mechanism of a cleaning unit shown in FIG. 2;

FIG. 4 is an exploded perspective view of a cap body and a first case body shown in FIG. 3; and

FIG. 5 is a cross-sectional view of the capping mechanism shown in FIG. 3.

### DETAILED DESCRIPTION OF EMBODIMENTS

Hereinafter, embodiments according to the present disclosure will be described with reference to the drawings.

(Schematic Configuration of Inkjet Printer)

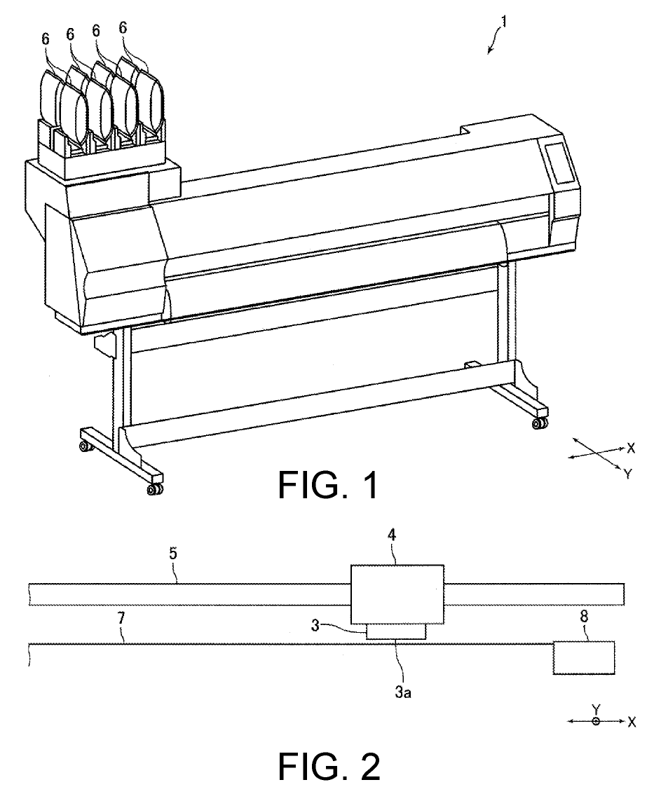

FIG. 1 is a perspective view of an inkjet printer 1 according to an embodiment of the present disclosure. FIG. 2 is a schematic view showing a carriage 4 and the like of the inkjet printer 1 shown in FIG. 1.

The inkjet printer 1 (hereinafter referred to as “printer 1”) of the present embodiment is a business inkjet printer, and prints on a medium such as paper. The printer 1 includes an inkjet head 3 (hereinafter referred to as a “head 3”) that ejects ink droplets toward a medium, a carriage 4 on which the head 3 is mounted, a carriage driving mechanism (not shown) that moves the carriage 4 in a main scanning direction (X direction in FIG. 1 etc.), a guide rail 5 that guides the carriage 4 in the main scanning direction, and a plurality of ink tanks 6 in which ink to be supplied to the head 3 is stored.

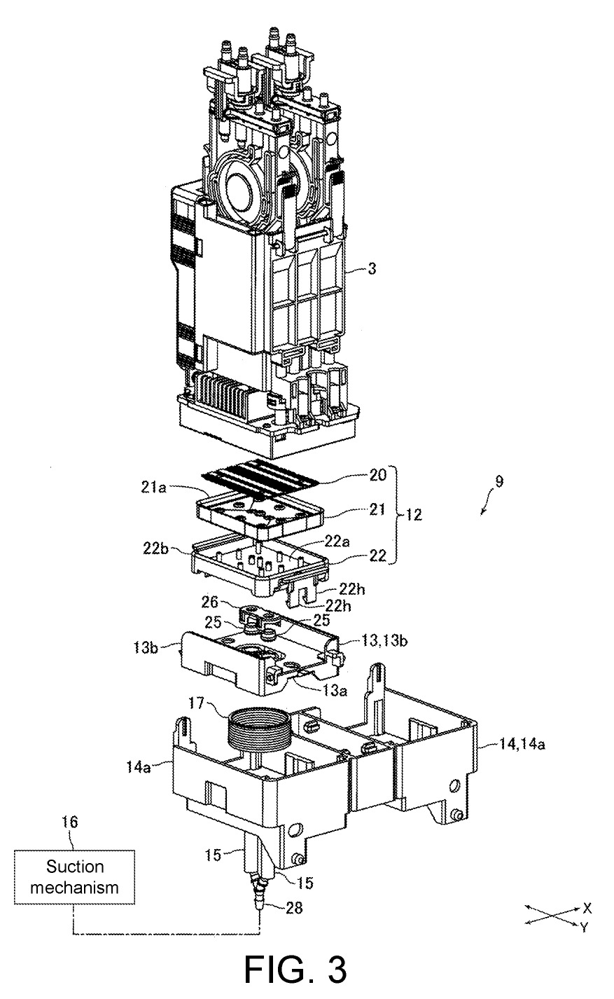

The head 3 ejects ink droplets toward a lower side. A nozzle surface (ink ejection surface) 3a in which a plurality of nozzles are arrayed is formed on a lower surface of the head 3. A platen 7 is disposed on the lower side of the head 3. A medium at the time of printing is placed on the platen 7. Furthermore, the printer 1 includes a cleaning unit 8 that cleans the nozzle surface 3a so as to prevent clogging of nozzles of the nozzle surface 3a. The cleaning unit 8 is disposed at a predetermined standby position of the carriage 4 which is a position deviated from a printing region of the medium in the main scanning direction. The cleaning unit 8 includes a capping mechanism 9 (see FIG. 3) that covers the nozzle surface 3a and suctions ink from the nozzles. Hereinafter, a configuration of the capping mechanism 9 will be described.

(Configuration of Capping Mechanism)

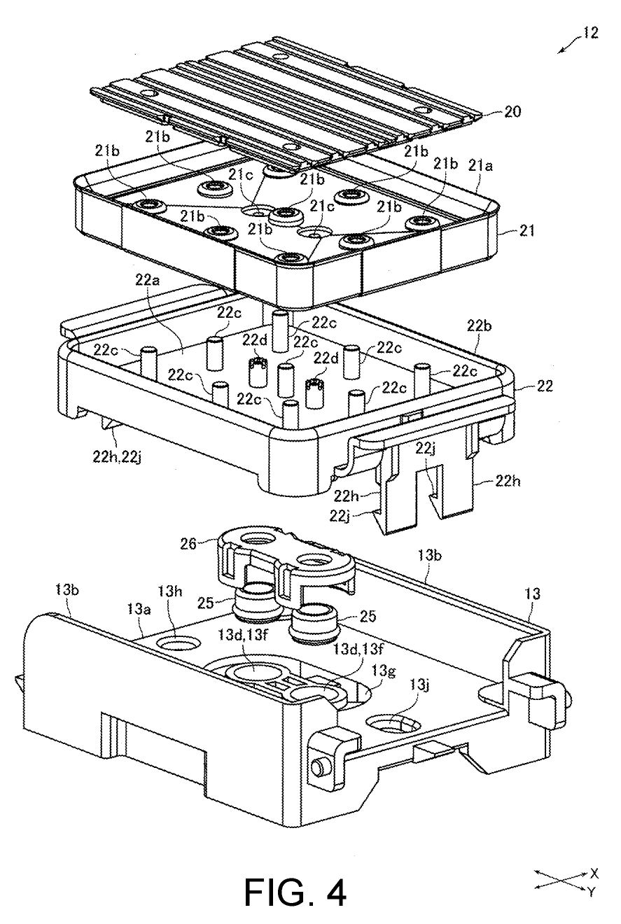

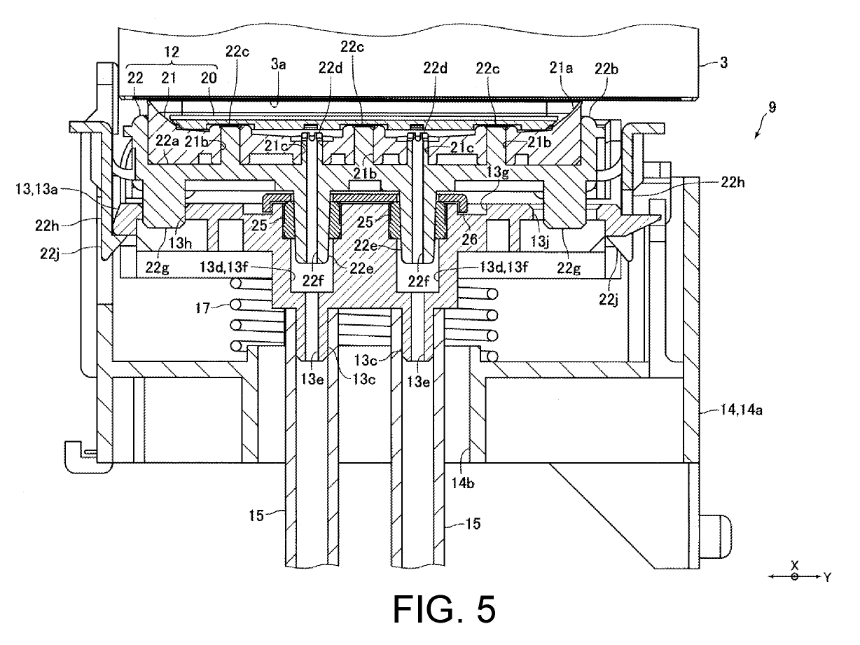

FIG. 3 is an exploded perspective view describing the configuration of the capping mechanism 9 of the cleaning unit 8 shown in FIG. 2. FIG. 4 is an exploded perspective view of a cap body 12 and a first case body 13 shown in FIG. 3. FIG. 5 is a cross-sectional view of the capping mechanism 9 shown in FIG. 3.

The capping mechanism 9 includes the cap body 12 that covers the nozzle surface 3a from the lower side, the first case body 13 to which the cap body 12 is detachably attached, and a second case body 14 that holds the first case body 13. The first case body 13 is held by the second case body 14 so as to be movable up and down. The cap body 12 is attached to the first case body 13 from an upper side, and the first case body 13 is attached to the second case body 14 from the upper side.

In the present embodiment, one cap body 12 is detachably attached to one first case body 13. Furthermore, two first case bodies 13 are held by one second case body 14 so as to be movable up and down. That is, in the present embodiment, two cap bodies 12 and two first case bodies 13 are held by one second case body 14 so as to be movable up and down. In FIG. 3, only one cap body 12 and one first case body 13 are shown.

The capping mechanism 9 includes a tube 15, one end of which is attached to the first case body 13, a suction mechanism 16 to which the other end of the tube 15 is connected, and a compression coil spring 17 serving as a biasing member that biases the first case body 13 to the upper side with respect to the second case body 14. In the following description, a main scanning direction (X direction in FIG. 1 etc.) is referred to as “left and right direction” and a Y direction in FIG. 1 or the like orthogonal to the vertical direction and the left and right direction is referred to as “front and back direction”.

The cap body 12 is configured by a liquid attaching member 20 made of resin, a rubber cap 21 made of rubber, and a cap holder 22 made of resin. The cap holder 22 is formed into a flat rectangular parallelepiped box shape having an upper surface side opened and a small thickness in the vertical direction. The rubber cap 21 is formed into a square or rectangular plate shape. The rubber cap 21 is attached to the cap holder 22 from the upper side. The liquid attaching member 20 is formed into a square or rectangular flat plate shape. The liquid attaching member 20 is disposed on the upper side of the rubber cap 21. A plurality of grooves extending in the front and back direction are formed on an upper surface of the liquid attaching member 20.

As described above, the cap holder 22 is formed into a rectangular parallelepiped box shape in which the upper surface side is opened, and includes a square or rectangular bottom portion 22a constituting a bottom surface of the cap holder 22 and a square tubular shaped side wall portion 22b constituting a side surface of the cap holder 22. A plurality of columnar protrusions 22c projecting out toward the upper side are formed on an upper surface of the bottom portion 22a. In the present embodiment, nine protrusions 22c are arranged at intervals in the front and back, and right and left directions. A height of the four protrusions 22c disposed at four corners of the bottom portion 22a is higher than a height of the remaining five protrusions 22c.

Two tubular projections 22d projecting out toward the upper side are formed at a center portion of the upper surface of the bottom portion 22a. The projection 22d is formed into a cylindrical shape. A height of the projection 22d is lower than the height of the protrusion 22c. Two cylindrical projections 22e projecting out toward the lower side are formed at a center portion of a lower surface of the bottom portion 22a. In other words, the cap body 12 is provided with two tubular projections 22e projecting out toward the lower side. The projection 22e is also formed into a cylindrical shape. However, an outer peripheral surface of the projection 22e is a tapered surface in which an outer diameter of the projection 22e becomes slightly smaller toward the lower side.

The two projections 22d are arranged with a space in the front and back direction, and the two projections 22e are arranged with a space in the front and back direction. When viewed in the vertical direction, a center of the projection 22d and a center of the projection 22e coincide. A through hole 22f extending from an upper end of the projection 22d to a lower end of the projection 22e is formed in the cap holder 22. An inner diameter of the through hole 22f is constant. Furthermore, two columnar protrusions 22g projecting out toward the lower side are formed on the lower surface of the bottom portion 22a. The two protrusions 22g are arranged on an outer side in the left and right direction of the two projections 22e.

An engagement piece 22h projecting out toward the lower side is formed on both front and back outer sides of the side wall portion 22b. In the present embodiment, two engagement pieces 22h are formed on both front and back outer sides of the side wall portion 22b, respectively. The two engagement pieces 22h arranged on both front and back outer sides of the side wall portion 22b, respectively, are arranged with a space in the left and right direction. The engagement piece 22h is formed into a flat plate shape having its thickness direction in the front and back direction. The engagement piece 22h is elastically deformable in the front and back direction with an upper end of the engagement piece 22h connected to the side wall portion 22b as a fulcrum.

The engagement piece 22h is engaged with the first case body 13 by snap-fit. In other words, the cap body 12 is provided with the elastically deformable engagement piece 22h that projects out toward the first case body 13 disposed on the lower side of the cap body 12 and that engages with the first case body 13 by snap-fit. The lower end of the engagement piece 22h is an engagement claw portion 22j formed into a hook shape. An upper end of the engagement claw portion 22j projects out toward an inner side in the front and back direction. An upper surface of the engagement claw portion 22j is a plane orthogonal to the vertical direction.

A square annular wall portion 21a rising toward the upper side is formed at an outer peripheral end of the upper surface of the rubber cap 21. Furthermore, the rubber cap 21 is provided with a plurality of through holes 21b through which the protrusions 22c of the cap holder 22 are inserted and two through holes 21c through which the projections 22d are inserted. The protrusion 22c is lightly press-fitted to the through hole 21b, and the projection 22d is lightly press-fitted to the through hole 21c. As described above, the rubber cap 21 is attached to the cap holder 22 from the upper side. A lower surface of the rubber cap 21 is in contact with the upper surface of the bottom portion 22a of the cap holder 22. An outer peripheral surface of the rubber cap 21 is in contact with an inner peripheral surface of the side wall portion 22b of the cap holder 22. An upper end of the rubber cap 21 (i.e., upper end of wall portion 21a) is disposed on the upper side of the upper end of the side wall portion 22b.

The liquid attaching member 20 is disposed on an inner peripheral side of the wall portion 21a of the rubber cap 21. The upper surface of the liquid attaching member 20 is disposed on the lower side of the upper end of the wall portion 21a. The liquid attaching member 20 is fixed to upper ends of the four protrusion 22c arranged at the four corners of the bottom portion 22a. A lower surface of the liquid attaching member 20 is in contact with upper end faces of the remaining five protrusions 22c excluding the four protrusions 22c arranged at the four corners. A gap is formed between the lower surface of the liquid attaching member 20 and an upper end surface of the projection 22d.

The first case body 13 is made of resin. The first case body 13 includes a base portion 13a having a square shape or a rectangular shape when viewed in the vertical direction and left and right wall portions 13b connected to both left and right ends of the base portion 13a. Two cylindrical projections 13c projecting out toward the lower side are formed on a lower surface of a center portion of the base portion 13a. Two recesses 13d recessed toward the lower side are formed on an upper surface of the center portion of the base portion 13a. The shape of the recess 13d viewed in the vertical direction is a circular shape.

The two projections 13c are arranged with a space in the front and back direction, and the two recesses 13d are arranged with a space in the front and back direction. When viewed in the vertical direction, a center of the projection 13c and a center of the recess 13d coincide. A through hole 13e is formed in the first case body 13 so as to extend from a lower end of the projection 13c to a bottom surface of the recess 13d. Furthermore, the recess 13d is recessed from an upper surface of the base portion 13a toward the lower side. That is, in the first case body 13, a through hole 13f constituted by the recess 13d and the through hole 13e is formed, and the through hole 13f penetrates through the first case body 13 in the vertical direction.

The projection 22e of the cap holder 22 is inserted into an upper end of the recess 13d. That is, the projection 22e is inserted into the upper end of the through hole 13f. A cylindrical seal member 25 formed from an elastic body is disposed at the upper end of the recess 13d. The seal member 25 is formed of rubber. The seal member 25 is disposed between an inner peripheral surface of the upper end (upper end of the through hole 13f) of the recess 13d and the outer peripheral surface of the projection 22e. The seal member 25 is in close contact with the inner peripheral surface of the upper end of the recess 13d and the outer peripheral surface of the projection 22e. The seal member 25 fulfills a function of preventing leakage of air and ink from between the inner peripheral surface of the upper end of the recess 13d and the outer peripheral surface of the projection 22e.

A seal holding member 26 for preventing the seal member 25 from coming off from the recess 13d is fixed to the upper surface of the center portion of the base portion 13a. The seal holding member 26 prevents the seal member 25 from coming off to the upper side. A recess 13g for attaching the seal holding member 26 is formed on the upper surface of the center portion of the base portion 13a.

Moreover, two through holes 13h and 13j, into which the protrusion 22g of the cap holder 22 is inserted, are formed in the base portion 13a. The through holes 13h and 13j penetrate through the base portion 13a in the vertical direction. The through hole 13h is a circular hole. The through hole 13j is a long hole having its longitudinal direction in the front and back direction. In the present embodiment, the cap holder 22 is positioned with respect to the first case body 13 in the front and back direction and the right and left direction by the two protrusions 22g and the through holes 13h and 13j. That is, the cap body 12 is positioned with respect to the first case body 13 in the front and back direction and the right and left direction by the two protrusions 22g and the through holes 13h and 13j.

The engagement piece 22h of the cap holder 22 is engaged with both front and back ends of the base portion 13a from the outer side in the front and back direction. The upper surfaces of the engagement claw portions 22j are in contact with a lower surfaces of both the front and back ends of the base portion 13a. In the present embodiment, the cap body 12 is attached to the first case body 13 by engaging the engagement piece 22h elastically deformable in the front and back direction with the upper end as a fulcrum to the base portion 13a. That is, in the present embodiment, the cap body 12 is fixed to the first case body 13 by snap-fit.

The second case body 14 includes two holding portions 14a for holding the first case body 13. The two holding portions 14a are arranged so as to be adjacent to each other in the left and right direction. The holding portion 14a is formed into a rectangular parallelepiped box shape in which an upper surface side is opened. The holding portion 14a holds the first case body 13 such that the first case body 13 is movable up and down. A through hole 14b penetrating in the vertical direction is formed at a center of a bottom portion of the holding portion 14a formed into the rectangular parallelepiped box shape.

An upper end of the compression coil spring 17 is in contact with a lower surface of the first case body 13 (specifically, lower surface of base portion 13a), and a lower end of the compression coil spring 17 is in contact with an upper surface of the bottom portion of the holding portion 14a formed into a rectangular parallelepiped box shape. The two projections 13c are disposed on an inner peripheral side of the compression coil spring 17. Furthermore, the compression coil spring 17 is disposed on an outer peripheral side of the through hole 14b. The holding portion 14a is provided with a regulating portion that regulates the movement of the first case body 13 to the upper side with respect to the holding portion 14a. Furthermore, the first case body 13 is held by the holding portion 14a so as to be movable up and down in a state the movement in the front and back direction and the right and left direction is regulated with respect to the holding portion 14a. A guide groove for guiding the first case body 13 in the vertical direction is formed in the holding portion 14a.

The tube 15 is a tube made of rubber or made of resin having flexibility. As described above, one end of the tube 15 is attached to the first case body 13. Specifically, as the projection 13c of the first case body 13 is inserted (lightly press-fitted) to an inner peripheral side of the one end of the tube 15, the one end of the tube 15 is attached to the first case body 13, and the one end of the tube 15 is attached to a lower end of the first case body 13. The inner peripheral side of the tube 15 is communicated with the through hole 13f.

The two tubes 15 into which the two projections 13c are inserted are routed to the lower side. Upper ends of the two tubes 15 are disposed in the through hole 14b of the holding portion 14a. The other ends of the two tubes 15 are connected to a Y joint 28. The Y joint 28 is connected to the suction mechanism 16 by way of a predetermined piping. That is, the other ends of the two tubes 15 are connected to the suction mechanism 16 by way of the Y joint 28 and the predetermined piping.

In the present embodiment, the cap body 12, the first case body 13, and the second case body 14 are raised accompanying the movement of the carriage 4 when the carriage 4 moves to a predetermined standby position deviated from the printing region of the medium. When the cap body 12, the first case body 13 and the second case body 14 are raised, the upper end of the wall portion 21a of the rubber cap 21 is brought into close contact with the lower surface of the head 3 by the biasing force of the compression coil spring 17, and the rubber cap 21 covers the nozzle surface 3a from the lower side. When the suction mechanism 16 is driven in such a state, ink is suctioned from the nozzles of the head 3.

That is, when the suction mechanism 16 is driven in a state where the cap body 12 covers the nozzle surface 3a and is in close contact with the head 3, ink is suctioned from the nozzles of the head 3. The suctioned ink is passed through the tube 15 and the like and is collected in a waste ink container. Furthermore, a part of the suctioned ink adheres to the liquid attaching member 20 and the rubber cap 21. The second case body 14 is biased toward the lower side by a spring member such as a tension coil spring.

(Main Effect of the Present Embodiment)

As described above, in the present embodiment, the one end of the tube 15, the other end of which being connected to the suction mechanism 16, is attached to the first case body 13. Furthermore, in the present embodiment, the cap body 12 covering the nozzle surface 3a of the head 3 from the lower side is detachably attached to the first case body 13. Therefore, in the present embodiment, the attachment/detachment task of the cap body 12 with respect to the first case body 13, to which the one end of the tube 15 is attached, merely needs to be carried out when replacing the cap body 12 to which the ink suctioned from the nozzles of the head 3 adheres. That is, in the present embodiment, the attachment/detachment work of the tube 15 with respect to the cap body 12 does not need to be carried out when replacing the cap body 12. Therefore, in the present embodiment, the replacement task of the cap body 12 can be simplified.

In the present embodiment, the cap body 12 is provided with the elastically deformable engagement piece 22h that projects toward the first case body 13 and engages with the first case body 13 by snap-fit, and the cap body 12 is detachably attached to the first case body 13 by snap-fit. Therefore, in the present embodiment, the attachment/detachment task of the cap body 12 with respect to the first case body 13 is facilitated compared to a case where the cap body 12 is detachably attached to the first case body 13 by screws. Therefore, in the present embodiment, the replacement task of the cap body 12 can be further simplified.

In the present embodiment, the first case body 13 is biased to the upper side with respect to the second case body 14 by the compression coil spring 17. Therefore, in the present embodiment, the upper end of the wall portion 21a of the rubber cap 21 can be reliably brought into close contact with the lower surface of the head 3 by the biasing force of the compression coil spring 17. Furthermore, in the present embodiment, since the seal member 25 is disposed between the inner peripheral surface of the upper end of the recess 13d of the first case body 13 and the outer peripheral surface of the cap holder 22, the leakage of air and ink suctioned by the suction mechanism 16 from between the first case body 13 and the cap body 12 can be prevented even if the cap body 12 is detachably attached with respect to the first case body 13.

### OTHER EMBODIMENTS

In the embodiment described above, an engagement piece that projects out toward the upper side may be formed in the first case body 13 instead of the engagement piece 22h being formed in the cap holder 22. This engagement piece is, for example, elastically deformable in the front and back direction with a lower end of the engagement piece as a fulcrum and is engaged with the cap holder 22 by snap-fit. That is, in place of the engagement piece 22h formed on the cap holder 22, an elastically deformable engagement that projects out toward the cap body 12 and engages with the cap body 12 by snap-fit may be formed on the first case body 13

In the embodiment described above, the cap body 12 may be detachably attached to the first case body 13 by screws. Furthermore, in the embodiment described above, one cap body 12 and first case body 13 may be held so as to be movable up and down by one second case body 14, or three or more cap bodies 12 and first case bodies 13 may be held so as to be movable up and down by one second case body 14. Moreover, in the embodiment described above, one end of the tube 15 is directly attached to the first case body 13, but one end of the tube 15 may be attached to the first case body 13 by way of a predetermined member.

In the embodiment described above, the first case body 13 may be biased to the upper side with respect to the second case body 14 by a spring member other than the compression coil spring 17. In the embodiment described above, the cap body 12, the first case body 13, and the second case body 14 are raised accompanying the operation of the carriage 4, but a raising/lowering mechanism for raising and lowering the cap body 12, the first case body 13, and the second case body 14 may be provided in the capping mechanism 9.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A capping mechanism that covers a nozzle surface of an inkjet head in which a plurality of nozzles are arrayed and suctions ink from the nozzles; the capping mechanism comprising:
a cap body that covers the nozzle surface from a lower side, a first case body to which the cap body is detachably attached, a tube having one end attached to the first case body, and a suction mechanism to which the other end of the tube is connected; wherein
when the suction mechanism is driven with the cap body covering the nozzle surface and brought into close contact with the inkjet head, ink is suctioned from the nozzles.

2. The capping mechanism according to claim 1, further comprising a second case body that holds the first case body such that the first case body is movable up and down, and a biasing member that biases the first case body to an upper side with respect to the second case body.

3. The capping mechanism according to claim 1, wherein either one of the cap body and the first case body is provided with an elastically deformable engagement piece that projects out toward the other one of the cap body and the first case body, and that engages the other one of the cap body and the first case body by snap-fit.

4. The capping mechanism according to claim 1, wherein
the cap body is attached to the first case body from the upper side,
one end of the tube is attached to a lower end of the first case body,
a through hole that passes through the first case body in a vertical direction and communicates to an inner peripheral side of the tube is formed in the first case body,
a tubular projection that projects out toward the lower side and is inserted to an upper end of the through hole is formed in the cap body, and
a seal member formed of an elastic body is disposed between an inner peripheral surface of the upper end of the through hole and an outer peripheral surface of the tubular projection.

5. An inkjet printer comprising:
the capping mechanism according to claim 1;
the inkjet head; and
a carriage on which the inkjet head is mounted.

6. An inkjet printer comprising:
the capping mechanism according to claim 2;
the inkjet head; and
a carriage on which the inkjet head is mounted.

7. An inkjet printer comprising:
the capping mechanism according to claim 3;
the inkjet head; and
a carriage on which the inkjet head is mounted.

8. An inkjet printer comprising:
the capping mechanism according to claim 4;
the inkjet head; and
a carriage on which the inkjet head is mounted.
